(19) United States
(12) Patent Application Publication
(10) Pub. No.: US 2026/0270734 A1
(43) Pub. Date: Sep. 10, 2026

(54) PEER-TO-PEER WIRELESS POWER TRANSMISSION ASSOCIATED WITH UAVS

(71) Applicant: International Business Machines Corporation, Armonk, NY (US)

(72) Inventors: Charan Acharya Chandrashekar, Bangalore (IN); Prasanna Alur Mathada, Bangalore (IN); Sudhakar T. Seshagiri, Bangalore (IN); Shwetha Gopalakrishna, Bangalore (IN)

(21) Appl. No.: 19/069,476

(22) Filed: Mar. 4, 2025

(51) Int. Cl. H04W 24/08; H02J 50/00; H04W 84/06

(52) U.S. Cl. CPC H04W 24/08; H02J 50/001; H04W 84/06

(57) ABSTRACT

An approach for dynamically selecting peer-to-peer (P2P) wireless power transmission (WPT) between UAV (unmanned aerial vehicle) to sustain longer flight time may be provided. The approach monitors a first energy level of a first UAV from a plurality of UAVs in a UAV communication network and based on the depleting energy level of the first UAV, the approach determines, a second UAV that has a second energy level greater than the first energy level. The approach requests the second UAV to share energy with the first UAV and instructs the second UAV to perform a transfer of the energy to the first UAV.

### TECHNICAL FIELD

The present invention relates generally to transportation, and specifically, for optimizing wireless power transmission associated with UAVs.

### BACKGROUND

UAVs (Unmanned Aerial Vehicles) are aircrafts without any human pilot or passengers on board. These UAVs can be remotely piloted or can fly autonomously. UAVs have been in use through various industry and function, such as, shipping and delivery, aerial photography, disaster management, wildlife monitoring, search and rescue etc. UAVs can be powered by various energy sources, depending on usage, such as, battery, fossil fuels, hybrid, solar powered and nuclear powered. The flight time of the UAVs are typically proportional to the energy capacity of those energy sources.

### BRIEF SUMMARY

According to an embodiment of the present invention, a computer-implemented method for dynamically selecting peer-to-peer (P2P) wireless power transmission (WPT) between UAV (unmanned aerial vehicle) in order to sustain longer flight time, the computer-implemented method comprising: monitoring a first energy level of a first UAV from a plurality of UAVs in a UAV communication network; responsive to depleting of the first energy level of the first UAV, determining, through the UAV communication network, a second UAV from the plurality UAVs that has a second energy level greater than the first energy level; requesting, through the UAV communication network, the second UAV to share energy with the first UAV; and performing a transfer of the energy from the second UAV to the first UAV.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a computing environment 100, according to embodiments of the present invention;

FIG. 2 is a high-level system architecture of a UAV environment, designated as UAV system 200, that is capable of performing various tasks in flight without energy depletion interruption, according to embodiments of the present invention;

FIG. 3 is, a block diagram of an exemplary system, depicting wireless charging between UAVs, in accordance with aspects of the invention, as charging scenario 300;

FIG. 4 illustrates a flowchart, as one embodiment, depicting the execution of power transmission program 150 as method 400, which monitor the battery level for UAVs and facilitates peer-to-peer wireless charging from other UAVs to stay airborne as long as required by the current tasks;

FIG. 5 depicts another flowchart, as alternative embodiment, illustrating the execution of power transmission program 150, as Method 500; and

FIG. 6 depicts yet another flowchart, as another alternative embodiment, illustrating the execution of power transmission program 150, as Method 600.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments for dynamically selecting peer-to-peer (P2P) wireless power transmission (WPT) between UAVs (unmanned aerial vehicle) in order to sustain longer flight time. The embodiment continuously monitors the required energy to execute the assigned task without interruption for UAVs. Furthermore, embodiments can intelligently identify optimal peer UAVs to transfer energy from those peer UAVs to other UAVs with low energy level.

Wireless power transmission (WPT) is the transmission of electrical energy without wires as a physical link. WPT can fall into two categories: near field and far field. With near field WPT, the power is transferred over short distances by magnetic fields using inductive coupling. With far Field WPT, the power is transferred by beams of electromagnetic radiation (e.g., laser, microwaves, etc.). Application for both types of WPT is dependent on distance. Thus, far field WPT is more advantagous over a longer distance than near field WPT.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

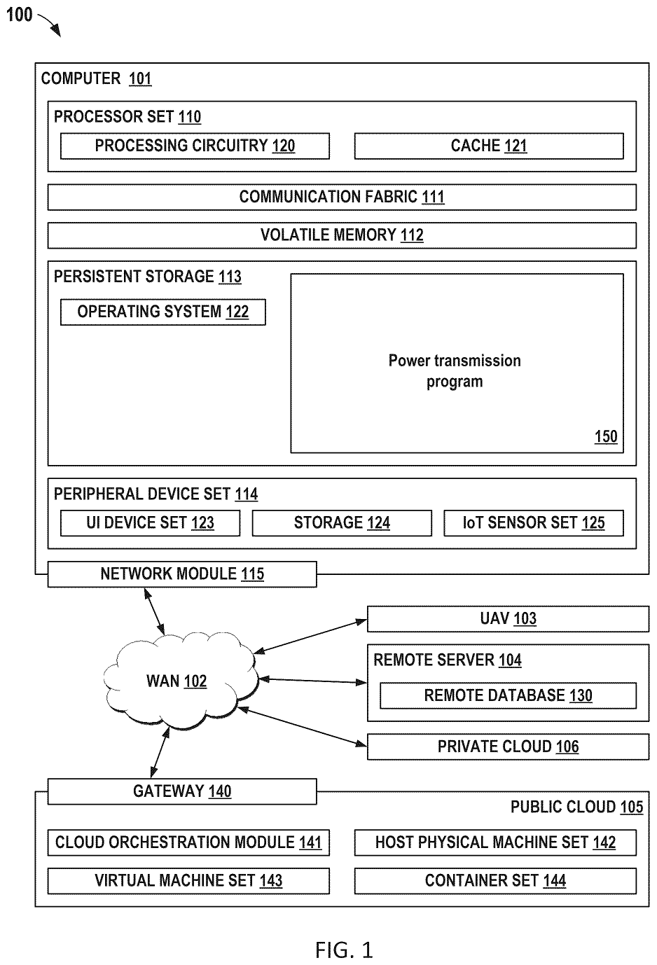

FIG. 1 includes computing environment 100, which contains an example of an environment for the execution of at least some of the computer code involved in performing the inventive methods. Computing environment 100 includes, for example, computer 101, wide area network (WAN) 102, UAV 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and power transmission program 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computing environment 100 contains an example of an environment for the execution of at least some of the computer code involved in performing the inventive methods, such as power transmission program 150. In addition to power transmission program 150, computing environment 100 includes, for example, computer 101, wide area network (WAN) 102, UAV 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and power transmission program 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in power transmission program 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150, referred to as power transmission program 150, typically includes at least some of the computer code involved in performing the inventive methods.

Power transmission program 150 provides the capability for a UAV to dynamically request energy from its peer UAVs. For example, one embodiment, power transmission program 150 creates a P2P (peer-to-peer) communication network between all the UAVs before the deployment so that UAVs can perform P2P communication. In the same embodiment, power transmission program 150 can periodically determine the energy needed to complete its assigned task (of the UAV) and compares it against the remaining energy level. If the UAVs needs to fly longer than what is planned, and remaining energy is less than the required energy, then the embodiment determines the additional energy needed to complete the assigned task. The UAV sends details, via P2P network, related to its energy needed and location details to its peer UAVs. The peer UAVs will receive the message and determine if it has enough energy to support the requesting UAV. That peer UAV may determine by considering its priority of its task, energy needed to execute its task, energy needed to reach the requester (i.e., low energy UAV) and requested energy (from the low energy UAV). If the peer UAV figures out that it has enough energy to support the requesting UAV, then it sends an acknowledgement along with the amount of energy it can transfer and would begin the energy transfer process. It is noted that power transmission program 150 may reside on UAV 103 or another device within computing environment 100.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

UAV (Unmanned Aerial Vehicle) 103 is an aircraft without any human pilot or passengers on board. The UAV 103 can be remotely piloted or can fly autonomously. UAVs 103 can be powered by various energy sources, depending on usage, such as, battery, fossil fuels, hybrid, solar powered and nuclear powered. Typically, the flight times of the UAVs 103 are proportional to the energy capacity of those energy sources. In the current disclosure, a battery as a UAV 103 energy source is discussed and used as example but the embodiment and/or approach from the embodiments can be applied to other types of energy source of UAVs 103. Furthermore, UAV 103 may be equipped with all the necessary hardware (e.g., transmitter, receiver, etc.) to support wireless power transfer (e.g., near field or far field) from the energy source of UAV 103 or any other energy transfer technology. It is noted that far field WPT may require additional hardware to help aim and/or align the transmitter with the receiver or vice versa to ensure a proper line of sight before transmitting (i.e., beaming) power.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

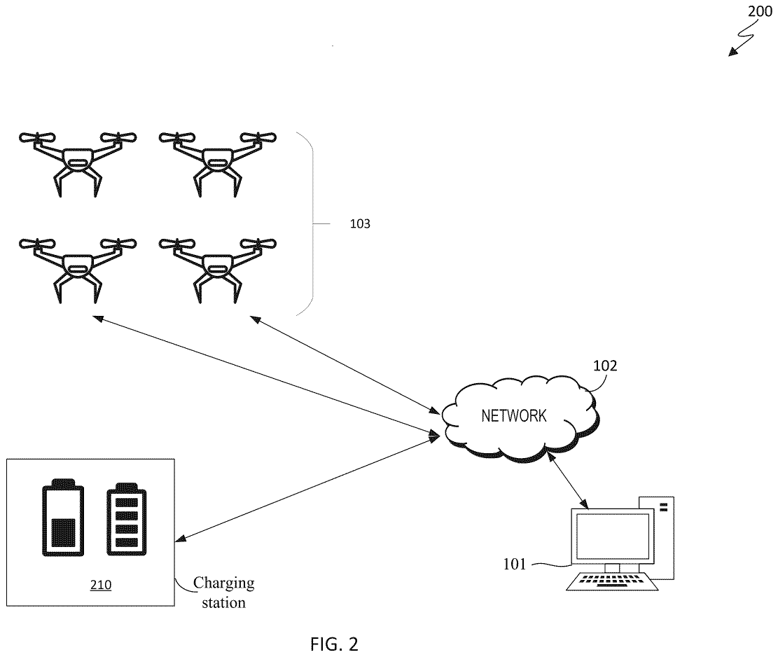

Referring now to various embodiments of the disclosure in more detail, FIG. 2 is a representation of UAV environment, designated as UAV system 200, that is capable of performing various tasks in flight without energy depletion or interruption. Many modifications to the depicted environment may be made by those skilled in the art without departing from the scope of the disclosure. UAV system 200 includes computer 101, WAN 102, UAV 103 and charging station 210.

Charging station 210 represents a location where UAV 103 can refuel or charge their energy source after depletion. Charging station 210 may include a physical location of edge computing infrastructure. Furthermore, charging station 210 may include storage location of UAV 103 when not in use in the field.

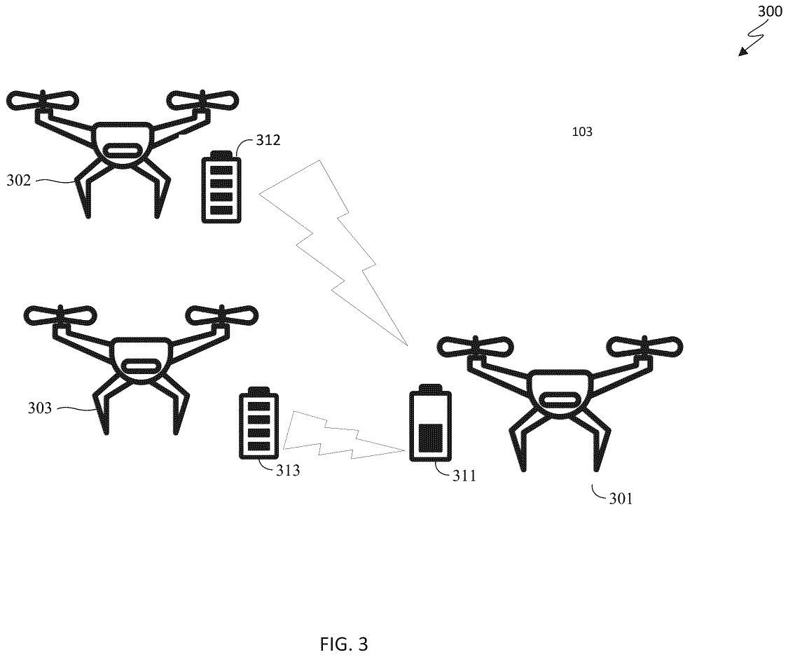

FIG. 3 show a block diagram of an exemplary system, depicting wireless charging between UAVs 103, in accordance with aspects of the invention, as charging scenario 300. Charging scenario 300 includes UAV one 301 with its battery, designated as battery one 311, UAV two 302 with its battery, designated as battery two 312, UAV three 303 with its battery, designated as battery three 313. Charging scenario 300 illustrates UAV one 301 has a nearly depleted battery but still has uncompleted tasks to perform. Thus, power transmission program 150, through UAV one 301, requests energy transfer from nearby UAV (e.g., UAV two 302 and UAV three 303). For example, after receiving a request and a confirmation that other nearby UAVs can fulfil the battery energy request then the battery transfer may occur. Thus, battery two 312 may being the wireless transfer of power to battery one 311. If battery two 312 does not have enough energy to completely charge battery one 301, then UAV three 303 can begin the energy transfer from battery three 313 to battery one 311.

A use case scenario will be provided to help illustrate FIG. 2 and FIG. 3.

### Use Case Scenario

Consider an example where UAVs are integrated with edge servers (i.e., computers that performs processing and storage at the edge of a network), known as UAV-MECs (mobile edge computing). These UAV-MECs (referring to FIG. 3, UAV one 301, UAV two 302 and UAV three 303) are deployed to a remote location for collecting and processing the data generated by IoT devices. If the data generated by IoT devices is more than expected or if there is a processing delay for whatsoever reason, then UAV one 301 will have to fly longer than what is planned. Thus, more flying time would mean more battery (i.e., energy level) needed. Therefore, if the battery level of UAV one 301 is close to depletion, then UAV one 301 would need to fly back to base location (i.e., charging station 210), recharge and then return for collecting data (i.e., UAV one 031 would be unable to finish its task). Consequently, this would mean that more data will still be generated by IoT devices and not being saved/stored since UAV one 301 has fly back to the base location to recharge and/or download gathered data.

Although, other option exists, such as, requesting another UAV-MECs (e.g., UAV two 302 and/or UAV three 303) to take over the original functionality of UAV one 301. However, some issues may arise, such as, the handing over/unloading task from one UAV-MECs to another UAV can be a time-consuming process which would disrupt continuity of processing the data (i.e., data could be lost). Other issues can include, confirming that compatible UAV-MECs with required capacity must be available and/or UAV-MECs must be loaded with required processing application etc.

Therefore, current embodiments of the present invention may alleviate the issues within the current art and provide one or more approaches to allow UAVs to remain airborne for a longer flight time in order to complete various tasks.

One embodiment of the present invention proposes a system and decentralized method for UAV-MECs to dynamically request energy from its peer UAV-MECs. A UAV communication network, such as P2P network, is created between all the UAV-MECs before the deployment so that UAV-MECs can perform P2P communication. For example, P2P communication may include Wi-Fi Direct®, Bluetooth® or any other radio wave technology like wireless mesh network, etc. After deployment UAV-MECs and it has reached the target location, embodiments can periodically determine the energy needed for deployed UAV-MECs (i.e., UAV one 301) to complete its assigned task and compares it against the remaining energy (i.e., battery of UAV one 311). Data such as, historical benchmarking may be used determine the energy needed to complete a particular task. For example, a typical processing time of 5 GB of data may need 5 minutes (i.e., 5 minutes of flying time=5V of energy or capturing 100 images needs 3 minutes=3+minutes of flying time=2 V of energy).

Furthermore, if UAV-MECs (i.e., UAV one 301) needs to fly longer than what is planned, and its remaining energy is less than the required energy then the power transmission program 150 determines the additional energy needed to complete the assigned task. For example, UAV-MECs (UAV one 301) sends details related to its energy needed and its location details to its peer UAVs. With the current embodiment, the maximum number of hops (to be reached) for requesting for energy can be defined by the user. For example: if maximum hop is 1 then UAV-MEC (i.e., UAV one 301) will reach to all the other UAV-MECs (e.g., UAV two 302 and UAV three 303) within immediate vicinity. It is noted that “hop” is defined as a predetermined distance between UAV-MECs. However, if a max hop is 2 then UAV one 301 can communicate to nearby UAV-MEC, such as UAV two 302 and that nearby UAVs can forward the request to another nearby UAV-MEC, such as UAV three 303 within it's a larger vicinity.

Additionally, peer UAV-MECs (e.g., UAV two 302 and UAV three 303) can receive the message and determine if it has enough energy to support the requesting UAV-MEC (i.e., UAV one 301) by considering its priority of its task, energy needed to execute its task, energy needed to reach the requester and requested energy. If a peer UAV-MEC determines that it has enough energy to support the requesting UAV (i.e., UAV one 301), then it sends an acknowledgement along with amount of energy it can transfer to UAV one 301. However, if the peer UAV-MEC determines that it cannot provide the requested energy, then it will check the maximum number of hops to which request needs to be forwarded. Conversely, if the peer UAV-MEC is at the last hop then it will do nothing, else it will forward the request to other UAVs within its reach. The request will be forwarded, iteratively, to other UAV-MECs until max hop is reached.

Once UAV one 301 receives an acknowledgement from its multiple peer UAVs, then UAV one 301 may pick an optimal peer that can provide energy, such as UAV two 302. Choosing which peer to select can be based on which peer UAV has a certain energy level and the distance of that peer. Thus, the term, “optimal peer” may include those recited requirements, i) remaining energy level and ii) distance from requesting UAV. After selecting a peer, UAV one 301 may then send a message to the optimal peer (i.e., UAV two 302) to confirm the request. Subsquently, both UAVs (i.e., UAV one 301 and UAV two 302) reach an agreed location and being to wirelessly transmits/transfer the energy. Is it noted that multiple peers can also transmit energy if a single UAV cannot provide the total requested energy.

### Other Figures and Embodiments

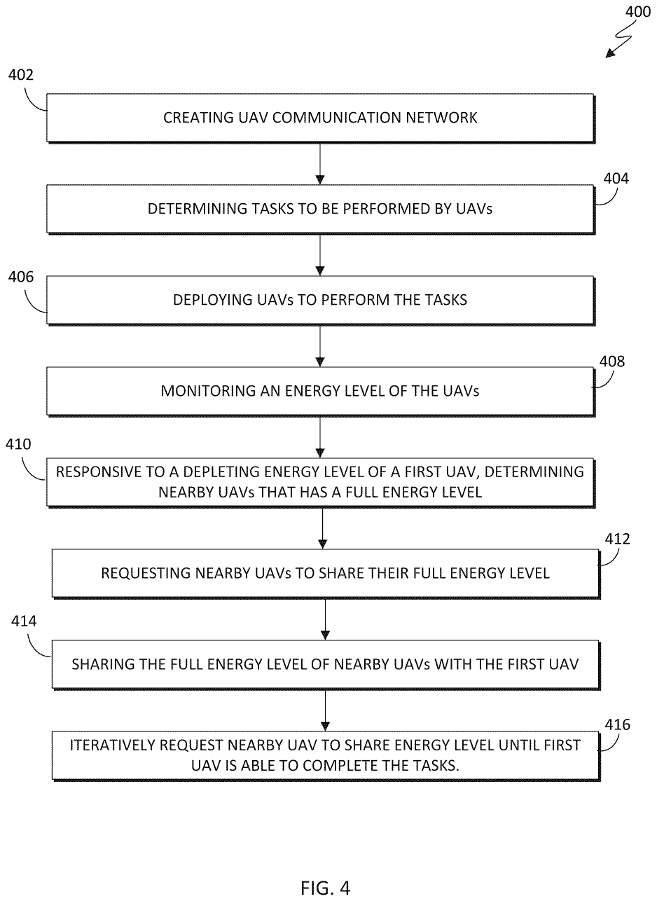

FIG. 4 illustrates a flowchart, as one embodiment, depicting the execution of Power transmission program 150 as method 400, which monitor the battery level for UAVs and facilitates peer-to-peer wireless charging from other UAVs to stay airborne as long as required by the current tasks.

At operation 402 of method 400, a UAV communication network associated with one or more UAVs 103 is created. A communication network is created between all the UAVs 103 before the deployment so that UAVs 103 can perform P2P communication.

At operation 404 of method 400, the one or more tasks to be performed by the one or more UAVs 103 are determined. The one or more tasks can include, but it is not limited, performing data collection for remote IoT devices (i.e., residing on terrains with poor data transmission and/or access), performing rescue missions of civilians (e.g., lost hikers in the woods, etc.), shipping and delivery, aerial photography, disaster management, wildlife monitoring, and performing entertainment tasks. It is noted that data collection of remote IoT device activities may be associated in the field of, but not limited to, agriculture, monitoring utility infrastructure (e.g., electricity grids, etc.) and transportation (e.g., roadways, bridges, etc.).

At operation 406 of method 400, the one or more UAVs 103 that have been selected to perform the one or more tasks are deployed.

At operation 408 of method 400, the energy level of a first UAV from the one or more UAVs 103 is being continuously monitored. For example, the battery level of a first UAV is being continuously monitored to determine if the first UAV can complete its tasks.

At operation 410 of method 400, once the power transmission program 150 has identified that the energy level of the first UAV is low, then the power transmission program 150 determines which nearby UAV 103 has more energy level than the first UAV (i.e., enough for the first UAV to complete its one or mor tasks). For example, after performing task A (of the one or more tasks) for 20 minutes, the battery level of the first UAV has dropped to 25%. This battery level is not enough to complete task A. Thus, power transmission program 150 would determine which nearby UAV 103 has adequate battery level to spare for the first UAV.

At operation 412 of method 400, power transmission program 150 requests the nearby UAV 103 to share their energy level. For example, the power transmission program 150 may solicit nearby UAV 103 (relative to the first UAV with the low battery) to share its battery level with the first UAV. This could be a second UAV that has 90% battery level and the second UAV only requires 20% of the battery to perform its own task. It is noted that “higher energy” level is relative to the requesting UAV (i.e., the first UAV). For clarity, a “higher energy” level means that nearby UAVs 103 have more energy level than the energy level of the requesting UAV.

At operation 414 of method 400, the first UAV shares the energy level of the nearby UAV from the one or more UAVs 103. Referring to the previous example, the second UAV can share up to 60% of its battery level to the first UAV (which may be or not enough for the first UAV to complete task A).

At operation 416 of method 400, the power transmission program 150 iteratively requests the nearby UAVs 103 to share the higher energy level with the first UAV until the first UAV is able to complete the one or more tasks. It is possible that 60% battery level transferred from the second UAV to the first UAV may not be enough for the first UAV to complete task A. Thus, another nearby UAV (e.g., a third UAV) may have to share its battery level.

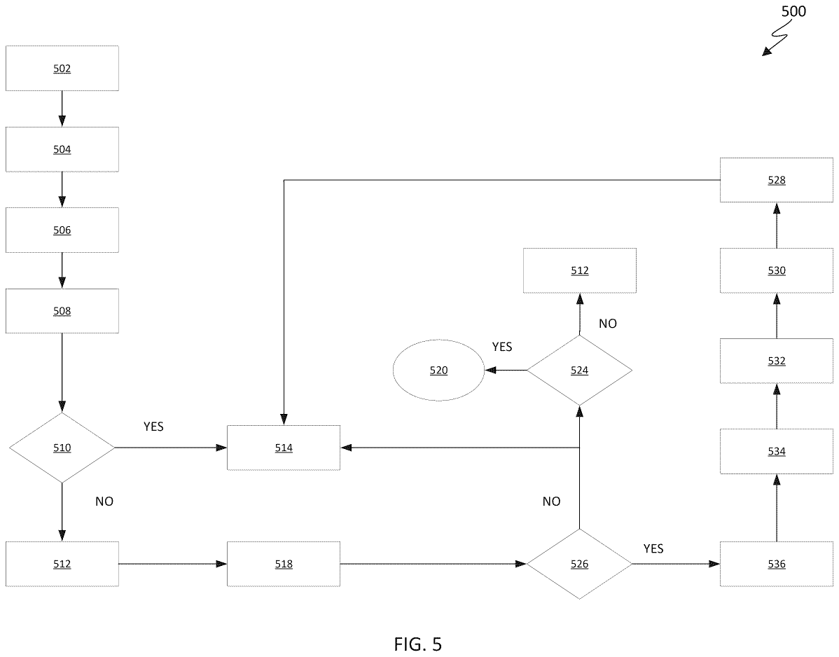

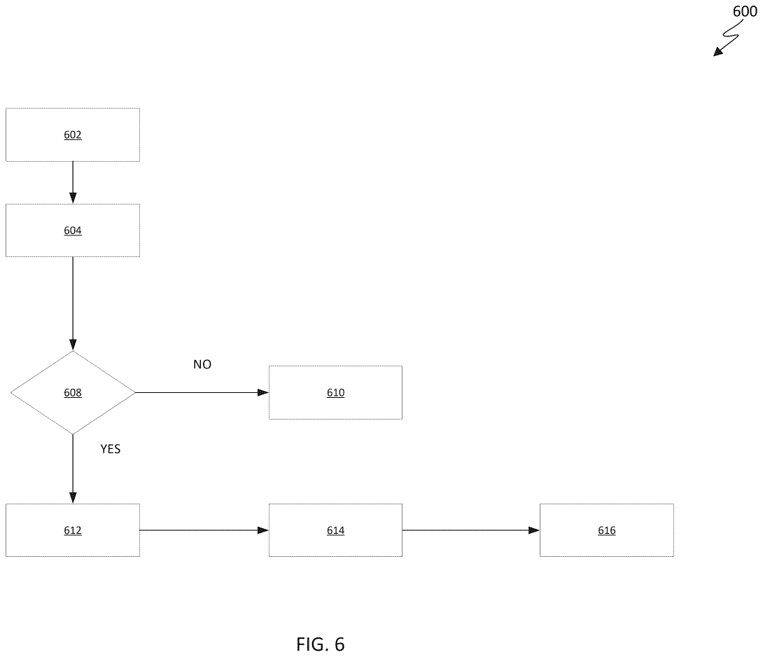

FIG. 5 depicts another flowchart, as alternative embodiment, illustrating the execution of power transmission program 150, as Method 500. It is noted that referring back to SCENARIO ONE may be helpful to understand method 500 and method 600 (of FIG. 6).

At operation 502 of method 500, a communication network between all UAV-MECs is created. A communication network is created between all the UAVs 103 before the deployment so that UAVs 103 can perform P2P communication.

At operation 504 of method 500, a maximum number of hops to which energy request (by the UAV-MECs) needs to be forwarded are defined. For example, if a maximum hop is denoted as 1 then the first UAV-MEC will reach all other nearby UAV-MECs. If a maximum hop is 2 then the first UAV-MEC will reach the nearby UAC-MECs and a second UAV-MECs can forward the energy request to a third UAV-MEC within its reach.

At operation 506 of method 500, UAV-MECs are deployed to a target location. At operation 508, UAV-MECs reaches its target location.

At operation 510 of method 500, the first UAV-MEC determines the energy required to execute the tasks. If the first UAV-MEC determines that it has enough energy to execute the task, then it proceeds to operation 514 (“YES” branch of block 510). At operation 514 of method 500, the first UAV-MEC executes the tasks and return to base locations.

However, if the first UAV-MEC does not have enough energy to execute the task then it proceeds to operation 512 (“NO” branch of block 510). At operation 512 of method 500, the first UAV-MEC sends information relating to its energy need and current location to nearby UAV-MECs. At operation 518 of method 500, a nearby UAV-MEC evaluates its task, energy needed to complete its task, requested energy from the first UAV-MEC and energy needed to travel to meet the first UAV-MEC.

At operation 526 of method 500, the nearby UAV-MEC determines whether it can provide the energy to the requesting UAV-MEC (i.e., first UAV-MEC). If the nearby UAV-MECs can provide the requested energy, then it proceeds to operation 536 (“YES” branch of block 526). However, if nearby UAV-MECs cannot provide the energy then the power transmission program 150 proceeds to operation 524 (“NO” branch of block 526).

At operation 524 of method 500, nearby UAV-MEC determines if the request from the first UAV-MEC is the final hop and check for help request. If nearby UAV-MEC determines that the final hop has been reached, then it does not need to forward a help request/message (operation 520). However, if nearby UAV-MEC determines that the final hop does not require a check for help, then power transmission program 150 proceeds to block 512 (“NO” branch of block 524).

At operation 536 of method 500, nearby UAV-MEC provides confirmation to the first UAV-MEC that there is enough energy for the request. At operation 534, the first UAV-MEC decides which nearby UAV-MEC to select based on, at least, but not limited to, i) distance, and ii) available energy. At operation 532, the first UAV-MEC sends a message to the selected nearby UAV-MEC (i.e., second UAV-MEC) to confirm the energy transfer. At operation 530, the selected nearby UAV-MEC (i.e., second UAV-MEC) reaches a transfer location. At operation 528, the second UAV-MEC transfers the energy (i.e., wirelessly) to the first UAV-MEC. Once the energy transferred has been completed then the first UAV-MEC can complete its task and return to base location (operation 514).

FIG. 6 depicts another flowchart, as alternative embodiment, illustrating the execution of power transmission program 150, as Method 600. It is noted that method 600 is a subsequent iteration to method 500 when nearby UAV-MECs do not have enough energy to transfer to the first UAV-MEC (i.e., starting at operation 602). Operation 602 denotes a starting point when nearby UAV-MECs are unable to fulfil the energy request from the first UAV-MEC. At operation 604, the first UAV-MEC resends a request to nearby UAV-MEC with a priority details. At operation 608, power transmission program 150 makes a determination whether the tasks being performed by the first UAV-MEC has more of a priority over nearby UAV-MEC's tasks. If power transmission program 150 determines that the nearby UAV-MEC's task takes precedent (i.e., higher priority) than the first UAV-MEC (“NO” branch of block 608) then nothing happens (i.e., operation 610). At operation 610, all nearby UAV-MECs continue with previously assigned tasks. However, if the priority of the first UAV-MEC is greater than the nearby UAV-MECs (“YES” branch of block 608) then the power transmission program 150 proceeds to operation 612.

At operation 612, the second UAV-MEC would off load (i.e., transfers) its task to another nearby UAV-MEC. At operation 614, the second UAV-MEC would fly to a transfer location for the first UAV-MEC. At operation 616, the second UAV-MEC would then proceed with the energy transfer. It is noted that the iteration of method 600 can be repeated many times with other UAV-MECs until a priority task is completed.

1. A computer-implemented method, the method comprising:
monitoring a first energy level of a first UAV from a plurality of UAVs in a UAV communication network;
responsive to depletion of the first energy level of the first UAV, determining, through the UAV communication network, a second UAV from the plurality UAVs that has a second energy level greater than the first energy level;
requesting, through the UAV communication network, the second UAV to share energy with the first UAV; and
performing a transfer of the energy from the second UAV to the first UAV.

2. The computer-implemented method of claim 1, wherein the UAV communication network is a P2P (peer-to-peer) communication that further comprises Wi-Fi Direct® or Bluetooth® protocol.

3. The computer-implemented method of claim 1, wherein the one or more tasks further comprise performing data collection for remote IoT devices residing on terrains with poor data transmission, performing rescue missions, performing entertainment tasks, and performing research and reconnaissance missions.

4. The computer-implemented method of claim 1, wherein monitoring the first energy level of the first UAV further comprises:
determining whether the first energy level of the first UAV is sufficient to complete the one or more tasks.

5. The computer-implemented method of claim 1, wherein performing the transfer further comprises:
locating and aligning a receiver on the first UAV with a transmitter of the second UAV; and
transmitting an electromagnetic radiation beam from the transmitter that is coupled to a battery source of the second UAV to the receiver of the first UAV.

6. The computer-implemented method of claim 1, wherein the plurality of UAVs are battery-powered UAVs.

7. The computer-implemented method of claim 1, further comprises:
iteratively requesting, through the UAV communication network, other UAVs from the plurality of UAVs to share the higher energy level with the first UAV until the first UAV can complete the one or more tasks.

8. A computer program product comprising:
one or more non-transitory computer readable storage media and program instructions stored on the one or more non-transitory computer readable storage media, the program instructions comprising the steps of:
monitoring a first energy level of a first UAV from a plurality of UAVs in a UAV communication network;
responsive to depleting of the first energy level of the first UAV, determining, through the UAV communication network, a second UAV from the plurality UAVs that has a second energy level greater than the first energy level;
requesting, through the UAV communication network, the second UAV to share energy with the first UAV; and
performing a transfer of the energy from the second UAV to the first UAV.

9. The computer program product of claim 8, wherein creating the UAV communication network is a P2P (peer-to-peer) communication that further comprises Wi-Fi Direct® or Bluetooth® protocol.

10. The computer program product of claim 8, wherein the one or more tasks further comprises of, performing data collection for remote IoTs (residing on terrains with poor data transmission), performing rescue missions, performing entertainment tasks and performing research and reconnaissance missions.

11. The computer program product of claim 8, wherein monitoring the first energy level of the first UAV further comprises:
determining whether the first energy level of the first UAV is sufficient to complete the one or more tasks.

12. The computer program product of claim 8, wherein sharing the higher energy level of the second UAVs from the plurality UAVs with the first UAV further comprises:
locating and aligning a receiver on the first UAV with a transmitter of the second UAV; and
transmitting an electromagnetic radiation beam from the transmitter that is coupled to a battery source of the second UAV to the receiver of the first UAV.

13. The computer program product of claim 8, wherein the plurality UAVs is a battery powered UAV.

14. The computer program product of claim 8, further comprises:
iteratively requesting, through the UAV communication network, the plurality of UAVs to share the higher energy level with the first UAV until the first UAV can complete the one or more tasks.

15. A computer system for predicting team dynamics based on changing circumstances, the computer system comprising:
one or more computer processors;
one or more non-transitory computer readable storage media; and
program instructions stored on the one or more non-transitory computer readable storage media, the program instructions comprising the steps of:
monitoring a first energy level of a first UAV from a plurality of UAVs in a UAV communication network;
responsive to depleting of the first energy level of the first UAV, determining, through the UAV communication network, a second UAV from the plurality UAVs that has a second energy level greater than the first energy level;
requesting, through the UAV communication network, the second UAV to share energy with the first UAV; and
performing a transfer of the energy from the second UAV to the first UAV.

16. The computer system of claim 15, wherein the one or more tasks further comprises of, performing data collection for remote IoTs (residing on terrains with poor data transmission), performing rescue missions, performing entertainment tasks and performing research and reconnaissance missions.

17. The computer system of claim 15, wherein monitoring the first energy level of the first UAV from the plurality of UAVs, further comprises:
determining the first energy level of the first UAV whether it has enough energy level to complete the one or more tasks.

18. The computer system of claim 15, wherein sharing the higher energy level of the second UAVs from the plurality UAVs with the first UAV further comprises:
locating and aligning a receiver on the first UAV with a transmitter of the second UAV; and
transmitting an electromagnetic radiation beam from the transmitter that is coupled to a battery source of the second UAV to the receiver of the first UAV.

19. The computer system of claim 15, wherein the plurality UAVs is a battery powered UAV.

20. The computer system of claim 15, further comprises:
iteratively requesting, through the UAV communication network, the plurality of UAVs to share the higher energy level with the first UAV until the first UAV can complete the one or more tasks.
